(19) United States
(12) Patent Application Publication
(10) Pub. No.: US 2021/0036855 A1
(43) Pub. Date: Feb. 4, 2021

(54) TRANSFERING TOKENS BETWEEN BLOCKCHAIN NETWORKS

(71) Applicant: INTERNATIONAL BUSINESS MACHINES CORPORATION, ARMONK, NY (US)

(72) Inventors: ROBERT KLENIEWSKI, Magdalenka (PL); Karolina Marzantowicz, Warszawa (PL); PIOTR P. GODOWSKI, Krakow (PL)

(21) Appl. No.: 16/923,200

(22) Filed: Jul. 8, 2020

(30) Foreign Application Priority Data
Jul. 31, 2019 (EP) 19189326.2

(51) Int. Cl. H04L 9/32; H04L 9/08; H04L 9/06; G06Q 20/40

(52) U.S. Cl. CPC H04L 9/3213; H04L 9/0822; H04L 2209/38; H04L 9/0643; G06Q 20/401; H04L 9/3236

(57) ABSTRACT

Embodiments relate to a method for transferring at least one source token of a source set of tokens from a source blockchain of a source blockchain network to a target blockchain of a target blockchain network. A method comprises providing an approval of the transfer, initiating an issuing transaction of at least one target token in the target blockchain of the target blockchain network, and verifying an annihilation of the at least one source token in the source blockchain of the source blockchain network.

### BACKGROUND

The present disclosure relates to the field of electronic data processing and, more specifically, to transferring a token of a source set of tokens from a source blockchain of a source blockchain network to a target blockchain of a target blockchain network.

A blockchain provides a shared ledger technology that members of a blockchain network may use to record transactions of tokens that cannot be altered. A blockchain provides a single point of truth: a shared, tamper-evident and/or tamper-proof ledger. A blockchain network provides technical infrastructure to manage the blockchain according to a set of rules specific for the respective blockchain network. The rules may, e.g., define which types of transactions are allowed in the respective blockchain network and how these transactions are to be performed. Thus, different blockchains are in general independent from each other and may be configured to handle different types of tokens. No predefined method is provided for transferring tokens from one blockchain network to another.

### SUMMARY

Various embodiments provide a method for transferring at least one source token of a source set of tokens from a source blockchain of a source blockchain network to a target blockchain of a target blockchain network as well as a computer program product and a computer system for executing the transferring as described by the subject matter of the independent claims. Advantageous embodiments are described in the dependent claims. Embodiments of the present invention can be freely combined with each other if they are not mutually exclusive.

In one aspect, the invention relates to a method for transferring at least one source token of a source set of tokens from a source blockchain of a source blockchain network to a target blockchain of a target blockchain network. The source blockchain network is configured for issuing and transferring the tokens of the source set of tokens within the source blockchain network using the source blockchain. The target blockchain network is configured for issuing and transferring tokens of a target set of tokens within the target blockchain network using the target blockchain.

The method comprises providing for a set of transfer conditions a receiver approval of the transfer of the at least one source token to the target blockchain network from a receiver. The receiver is a member of the target blockchain network authorized to initiate an issuing of at least one target token extending the target set of tokens within the target blockchain network. The set of transfer conditions with the receiver approval is configured to be usable for verifying a successful annihilation of the at least one source token in the source blockchain. An issuing transaction of the at least one target token in the target blockchain of the target blockchain network is initiated by the receiver. The issuing transaction is assigned with metadata. The metadata comprises the set of transfer conditions with the receiver approval. Validity of the at least one target token within the target blockchain network requires a successful verification of the annihilating of the at least one source token in the source blockchain. The annihilation of the at least one source token in the source blockchain of the source blockchain network is verified using the set of transfer conditions with the receiver approval.

Embodiments may have the beneficial effect of providing an efficient and secure way of enabling a transfer between independent blockchain networks ensuring that no doubling of tokens may occur.

Transferring tokens, i.e., digital assets of value, between separated blockchain networks introduces the risk of doubling the number of circulating tokens and hence the risk of digitally doubling the number of circulating assets. The digital assets may for example represent real-world assets. Thus, in case of a doubling of the digital assets there may be a risk of contradicting handling of the digital assets in the different blockchain networks, while there is only one real-world asset. Embodiments may have the beneficial effect of enabling to verify if a total amount of usable and circulated tokens for both blockchain networks remains the same before and after a token transfer from one blockchain network to another. Embodiments may introduce a way of transferring tokens between source and target blockchain networks based on a proof that transferred tokens in the target network are pledged, i.e., backed, by burnt, i.e., annihilated, tokens in the source blockchain network. Burnt tokens in the source blockchain network are unusable and the information linked to tokens in the target blockchain network resulting from the transfer may allow to verify the state of annihilation.

Thus, embodiments may ensure that after a transfer target tokens in the target blockchain are backed by annihilated source tokens in source blockchain. Furthermore, an issuance immutable transaction in the target blockchain may comprise information to find the annihilated source token in the source blockchain and to verify the state of annihilation. For finding the annihilated token, which is unusable, e.g., non-spendable, the information may comprise a public key identifying an annihilation destination address in the source blockchain to which the respective token has been transferred for annihilation.

In a further aspect, the invention relates to a computer program product for transferring at least one source token of a source set of tokens from a source blockchain of a source blockchain network to a target blockchain of a target blockchain network. The source blockchain network is configured for issuing and transferring the tokens of the source set of tokens within the source blockchain network using the source blockchain. The target blockchain network is configured for issuing and transferring tokens of a target set of tokens within the target blockchain network using the target blockchain.

The computer program product comprises a computer readable storage medium having program instructions embodied therewith. The program instructions are executable by a computer system to cause the computer system to provide for a set of transfer conditions a receiver approval of the transfer of the at least one source token to the target blockchain network from a receiver. The receiver is a member of the target blockchain network authorized to initiate an issuing of at least one target token extending the target set of tokens within the target blockchain network. The set of transfer conditions with the receiver approval is configured to be usable for verifying a successful annihilation of the at least one source token in the source blockchain. An issuing transaction of the at least one target token in the target blockchain of the target blockchain network is initiated by the receiver. The issuing transaction is assigned with metadata. The metadata comprises the set of transfer conditions with the receiver approval. Validity of the at least one target token within the target blockchain network requires a successful verification of the annihilating of the at least one source token in the source blockchain. The annihilation of the at least one source token in the source blockchain of the source blockchain network is verified using the set of transfer conditions with the receiver approval.

In a further aspect, the invention relates to a computer system for transferring at least one source token of a source set of tokens from a source blockchain of a source blockchain network to a target blockchain of a target blockchain network. The source blockchain network is configured for issuing and transferring the tokens of the source set of tokens within the source blockchain network using the source blockchain. The target blockchain network is configured for issuing and transferring tokens of a target set of tokens within the target blockchain network using the target blockchain.

The computer system comprising a processor and a memory storing computer-executable program instructions. Execution of the program instructions by the processor causing the processor to control the computer system to provide for a set of transfer conditions a receiver approval of the transfer of the at least one source token to the target blockchain network from a receiver. The receiver is a member of the target blockchain network authorized to initiate an issuing of at least one target token extending the target set of tokens within the target blockchain network. The set of transfer conditions with the receiver approval is configured to be usable for verifying a successful annihilation of the at least one source token in the source blockchain. An issuing transaction of the at least one target token in the target blockchain of the target blockchain network is initiated by the receiver. The issuing transaction is assigned with metadata. The metadata comprises the set of transfer conditions with the receiver approval. Validity of the at least one target token within the target blockchain network requires a successful verification of the annihilating of the at least one source token in the source blockchain. The annihilation of the at least one source token in the source blockchain of the source blockchain network is verified using the set of transfer conditions with the receiver approval.

### BRIEF DESCRIPTION OF THE SEVERAL VIEWS OF THE DRAWINGS

In the following, embodiments of the invention are explained in greater detail, by way of example only, making reference to the drawings in which:

FIG. 1 depicts a schematic diagram illustrating an exemplary computer system for transferring tokens between blockchain networks according to an embodiment,

FIG. 2 depicts a general schematic flow diagram of an exemplary method for transferring at a token from a source blockchain network to a target blockchain network, and

FIGS. 3A, 3B, and 3C depict a detailed schematic flow diagram of an exemplary method for transferring at a token from a source blockchain network to a target blockchain network.

### DETAILED DESCRIPTION

The descriptions of the various embodiments of the present invention are being presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments may have the beneficial effect of being blockchain technology agnostic. Embodiments may be used with any blockchain technology, i.e., blockchain networks, e.g., including blockchain networks based on an Unspent Transaction Output (UTXO) model or an account/balance record booking model. According to embodiments, the only requirement may be that the target blockchain network allows for metadata being added to transaction recorded in the target blockchain, like, e.g., a memo field.

Embodiments may have the beneficial effect that there is no need of usage of any specific consensus protocols like PoW, PoS etc. Embodiments may rather be implemented using atomic cryptographic functions, e.g. hashing one-way function, digital signature, signature verification, etc. Embodiments may have the beneficial effect of being effective and efficient.

According to embodiments, a transfer refers to an annihilation of at least one source token in a source blockchain of a source blockchain network and a parallel issuing of least one target token equivalent to the source token in a target blockchain of a target blockchain network. Thus, the source token in the source blockchain network may be replaced by a target blockchain in the target blockchain network. Embodiments may provide a verifiable and irreversible method of transferring tokens between two unrelated blockchain networks by executing a sequence of tasks. The sequence of task may comprise tasks being performed by a first actor, i.e., a receiver from the target blockchain network, and verifying tasks performed by a second actor, i.e., a sender from the source blockchain network. The receiver may be a receiver of the transferred tokens in the target blockchain (target BC), i.e., target ledger. In examples, discussed below the receiver may be referred to as Bob. The sender may, e.g., be an owner of tokens in the source blockchain source (BC), i.e., source ledger. In examples, discussed below the sender may be referred to as Alice.

According to embodiments, the transfer of the token may comprise three phases. In a first phase it is agreed on the transfer conditions, i.e., the receiver approval by the receiver (Bob) is provided. Both parties Alice and Bob may agree to the same form of data record providing a set of transfer conditions to be used for verifying a proper annihilation of tokens to be done by Alice in the source blockchain and for verifying a proper issuing of tokens to be done by the Bob in the target blockchain. The respective data record with the set of transfer conditions may be publicly accessible for everyone. The data record may comprise, e.g., a random nonce created and digitally signed by Alice (nonce_a), random nonce created and digitally signed by Bob (nonce_b) as well as auxiliary data added by any of the two parties.

In a second phase, tokens may be issued in the target blockchain by Bob. Bob may initiate an issuing, e.g., issuing himself, tokens in the target blockchain by digitally signing issuance transaction for the respective tokens which may comprise the data record created during phase 1 as metadata. The tokens created in the target blockchain are intended to replace the tokens to be annihilated in the source blockchain. The tokens created may have the same attributes as the tokens to be annihilated. A number of the tokens created by Bob may be the same as the number of tokens to be annihilated by Alice. For example, values may be assigned to the tokens which are the same or comparable for the tokens created and for the tokens to be annihilated. At the end of the second phase, tokens are issued by Bob but they are not backed by annihilated tokens yet. This state may be verifiable using the metadata of Bob's issuing transaction. The token issued may not be valid as long as there is no verification of the annihilation. They may even be restricted from being further transferred within the target blockchain network until verification of annihilation. Since the state of annihilation is publicly verifiable, they may, e.g., only be accepted by receivers of further transactions within the target blockchain network, if the annihilation is successfully verified. If the transfer stops at this phase the issued tokens may be considered invalid and thus be useless.

In a third phase, the annihilation of the tokens to be transferred in the source blockchain may be verified. Alice has to annihilate the tokens in the source blockchain. For this purpose, Alice may validate the token issuance transaction performed by Bob in the target blockchain. Alice may check that the issued tokens satisfy the transfer conditions agreed on, e.g., the number and/or value of tokens issued by Bob. Alice may use a public known one-way function on the publicly accessible data record agreed on during the first phase to produce an account public key from which tokens can never be spent because the private key of such an account is unknown to anybody including Alice and Bob. Alice may transfer her tokens to such an account making it non-spendable in the source blockchain network due to the unknown private key counterpart. At the end of the third phase, the transfer transaction is completed and the issuance as well as the annihilation are both verifiable. Bob may verify the annihilation of tokens in the source blockchain backing the tokens.

Bob and/or any other party may verify that Alice has indeed annihilated tokens by executing the one-way function on the data record provided as metadata of the issuing transaction to find using the account public key the annihilation destination address in the source database, to which the tokens have to be transferred for annihilation, and checking the account balance. Alice and/or any other party may validate that the tokens issued by Bob are actually backed by the tokens annihilated by Alice using the immutable issuance transaction created by Bob in the target blockchain for issuing the respective tokens.

Embodiments may have the beneficial effect that any party may be enabled to check if transferred tokens are non-spendable in the source blockchain and that there are, e.g., exactly the same number and/or values of tokens created in the target blockchain due to the public known one-way function and the data record provided as metadata. Alice may not be able to counterfeit the process due to existence of the receiver approval, e.g., nonce_b digitally signed by Bob, and Bob may not be able to counterfeit the process due to existence of a sender approval, e.g., nonce_a digitally signed by Alice, in the set of transfer condition provided by the metadata.

According to embodiments, the receiver (Bob) may issue further tokens in the target blockchain network for other members of the source blockchain network. Bob may transfer the issued tokens to accounts, i.e. destination addresses, assigned to Alice or another member of the source blockchain network. Any token holder of tokens in the target blockchain network may verify that such token issued and distributed by Bob are indeed backed by annihilated tokens in the source blockchain network. The respective token holders may follow the chain of transactions back to Bob's initial issuing transaction, read the metadata assigned to the initial issuing transaction and use the metadata to determine the annihilation destination address in the source blockchain, e.g. applying a one-way function to at least a part of the respective metadata. The annihilation destination address may be used to check the balance of the annihilation destination address in the source blockchain and comparing attributes of the annihilated tokens, like number, value etc., with attributes of the tokens issued by Bob in the target blockchain. In case the attributes of annihilated and issued tokens satisfy the transfer conditions agreed on, the issued tokens are valid and backed by the annihilated tokens. For example, if a number of tokens issued by Bob in the target blockchain is equal or less than a number of annihilated tokens in the source blockchain, the tokens issued by Bob may be accepted as being backed by tokens annihilated by Alice, i.e., the tokens may have been successfully transferred between blockchain networks. If the annihilation destination address does not exist in the source blockchain network or if attributes of the tokens issued by Bob in the target blockchain network do not satisfy the transfer conditions, e.g., if the number of issued tokens in the target blockchain is larger than the number of tokens annihilated in the source blockchain, the transfer of tokens between the blockchain networks may be invalid.

For example, the checks described above may be executed by any member of the target blockchain network prior to making a decision on buying and/or receiving tokens issued by Bob.

According to embodiments, the receiver approval comprises a receiver nonce signed with a receiver private cryptographic key assigned to the receiver. The signature with the receiver private cryptographic key is verifiable using a receiver public cryptographic key counterpart of the receiver private cryptographic key. Embodiments may have the beneficial effect of providing a cryptographically secure and efficiently verifiable approval.

According to embodiments, the method further comprises receiving for the set of transfer conditions a sender approval of the transfer of the at least one source token to the target blockchain network from a sender. The sender is a member of the source blockchain network authorized to initiate a transfer of the at least one source token within the source blockchain network. Embodiments may have the beneficial effect of ensuring that an authorized member of the source blockchain network approves the transfer.

According to embodiments, the received sender approval comprises a sender nonce signed with a sender private cryptographic key assigned to the sender. The method further comprises verifying the received sender approval using a sender public cryptographic key counterpart of the sender private cryptographic key. Embodiments may have the beneficial effect of providing a cryptographically secure and efficiently verifiable approval.

According to embodiments, the sender approval is received from the sender as part of a transfer request for transferring the at least one source token from the source blockchain network to the target blockchain network. Embodiments may have the beneficial effect of implementing an efficient and effective initiating procedure for the transfer.

According to embodiments, the transfer request comprises at least one attribute of the at least one source token to be transferred. Embodiments may have the beneficial effect of enabling the receiver of the target blockchain to generate a target token equivalent to the source token, such that the target token in the target blockchain may replace the annihilated source token in the source blockchain resulting in an effective transfer from the source to the target blockchain network.

According to embodiments, the method further comprises sending the receiver approval to the sender for verification. Embodiments may have the beneficial effect of enabling the sender to incorporate the receiver approval in the annihilation process. According to embodiments, a first verification confirmation of the verification of the receiver approval is received from the sender.

According to embodiments, the receiver is a member of the source blockchain network as well, authorized to initiate a transfer of the at least one source token within the source blockchain network. Embodiments may have the beneficial effect that the transfer may be executed by a single actor, e.g., person or entity, which is a member of both blockchain networks. Regarding the examples following below, the actions of the two actors, i.e., Alice and Bob, may be performed by a single actor. In such case a single approval, e.g. a single signed nonce (nonce_ab), may be used to verify correctness of the transfer process. Furthermore, transfer of information, e.g. sending of requests and confirmations, becomes unnecessary, since the single actor is already in position of all the information and knows about the actions he performs.

According to embodiments, the set of transfer conditions assigned to the issuing transaction of the at least one target token as metadata are publicly accessible. Embodiments may have the beneficial effect that anyone is enable the verify the transfer using the transfer conditions.

According to embodiments, the method further comprises sending an identifier of a destination address of the issuing transaction of the at least one target token to the sender for verification. Embodiments may have the beneficial effect of enabling the sender to verify the issuing prior to an annihilation of the at least one source token. According to embodiments, the method further comprises receiving a second verification confirmation of the verification of the issuing transaction from the sender.

According to embodiments, destination addresses for transfers of the tokens of the source set of tokens within the source blockchain network are calculated using a public cryptographic key. For transfers of the tokens of the source set of tokens from the destination addresses a private cryptographic key counterpart of the public cryptographic key used for calculating the respective destination address is required.

The verification of the annihilation comprises determining if the at least one source token has been transferred to an annihilation destination address within the source blockchain network.

The calculation of the annihilation destination address comprises applying a first one-way function on at least a portion of the set of transfer conditions, the portion of the set of transfer conditions at least comprising the receiver approval and the sender approval and using the result of the first one-way function as a public cryptographic key with no private cryptographic key counterpart for the calculating of the annihilation destination address. The at least one source token is non-transferable from the annihilation destination address due to the non-existing of a private cryptographic key counterpart of the public cryptographic key resulting from the first one-way function. Embodiments may have the beneficial effect of enabling an effective annihilation of the at least one source token which is based on an input from both parties, preventing the sender from tampering with the annihilation.

According to embodiments, the first one-way function is a first hash function. According to embodiments, the calculation of the destination address comprises applying a second one-way function to the result of the first one-way function. The destination addresses may in general be the result of a one-way function applied to public cryptographic keys. According to embodiments, the second one-way function is a second hash function.

According to embodiments, the portion of the set of transfer conditions comprises the full set of transfer conditions. Embodiments may have the beneficial effect that not only the approvals, but also auxiliary data defining the token to be transferred, like attributes, may be taken into account.

According to embodiments, the verifying of the annihilation further comprises checking that the annihilated at least one source token satisfies the transfer conditions according to the set of transfer conditions. Embodiments may have the beneficial effect of ensuring that indeed a transfer is performed. According to embodiments, a transfer condition of the set of transfer conditions defines an attribute of the at least one source token.

According to embodiments, the at least one target token is required to comprise the same attribute as defined by the transfer condition of the set of transfer conditions for the at least one source token. Embodiments may have the beneficial effect of ensuring that the source token in the source blockchain is replaced by an equivalent target token in the target blockchain.

According to embodiments, if the verifying of the annihilation is successful, a third verification confirmation of the annihilation of the at least one source token is sent to the sender. Embodiments may have the beneficial effect of informing the receiver of the annihilation.

According to embodiments, the set of transfer conditions is provided in form of a JSON file.

According to embodiments, a plurality of source token is transferred from the source blockchain of the source blockchain network to the target blockchain of the target blockchain network. The set of transfer conditions comprises transfer conditions for the plurality of source token. The receiver approval approves the transfer of the plurality of source token. The issuing transaction defines an issuing of one or more target token such that the one or more target token issued satisfy the transfer conditions of the set of transfer conditions. The verifying of the annihilation is performed for each source token of the plurality of source token.

According to embodiments, the computer program product further comprises machine-executable program instructions configured to implement any of the embodiments of the method for transferring at least one source token of a source set of tokens from a source blockchain of a source blockchain network to a target blockchain of a target blockchain network described herein.

According to embodiments, the computer system further is configured to execute any of the embodiments of the method for transferring at least one source token of a source set of tokens from a source blockchain of a source blockchain network to a target blockchain of a target blockchain network described herein.

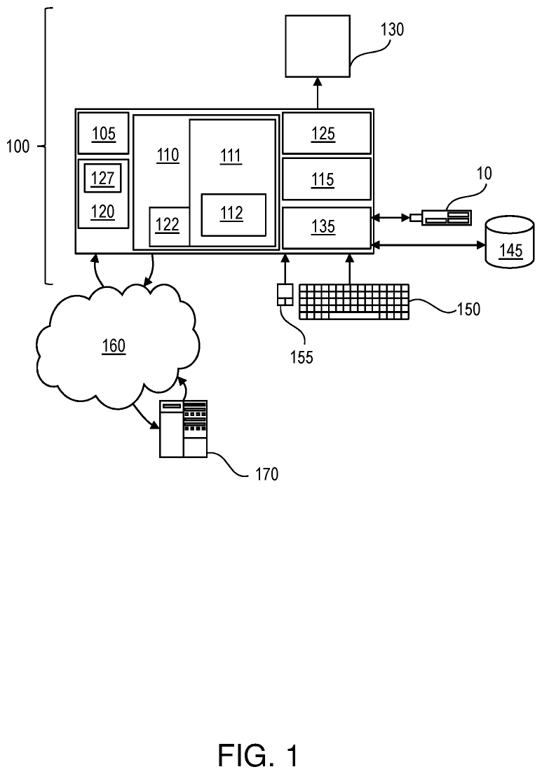

FIG. 1 shows an exemplary computer system 100 configured for transferring at least one source token of a source set of tokens from a source blockchain of a source blockchain network to a target blockchain of a target blockchain network. The computer system 100 may be a member, may be used by a member or may be provided with information identifying a member of the target blockchain network. The computer system 100 may comprise and/or have access to a copy of the target blockchain. The computer system 100 may further comprise and/or have access to a copy of the source blockchain. It will be appreciated that the computer system 100 described herein may be any type of computerized system comprising a plurality of plurality of processor chips, a plurality of memory buffer chips and a memory. The computer system 100 may for example be implemented in form of a general-purpose digital computer, such as a personal computer, a workstation, or a minicomputer.

In exemplary embodiments, in terms of hardware architecture, as shown in FIG. 1, the computer system 100 includes a processor 105, memory (main memory) 110 coupled to a memory controller 115, and one or more input and/or output (I/O) devices (or peripherals) 10, 145 that are communicatively coupled via a local input/output controller 135. The input/output controller 135 can be, but is not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer system 100, a semiconductor-based microprocessor (in the form of a microchip or chip set), a macroprocessor, or generally any device for executing software instructions.

The memory 110 can include any one or combination of volatile memory modules (e.g., random access memory (RAM, such as DRAM, SRAM, SDRAM, etc.)) and nonvolatile memory modules (e.g., ROM, erasable programmable read only memory (EPROM), electronically erasable programmable read only memory (EEPROM), or programmable read only memory (PROM)). Note that the memory 110 can have a distributed architecture, where additional modules are situated remote from one another, but can be accessed by the processor 105.

The software in memory 110 may include one or more separate programs, each of which comprises an ordered listing of executable instructions for implementing logical functions, notably functions involved in embodiments of this invention. For example, the executable instructions may be configured to perform a transfer of at least one source token of a source set of tokens from a source blockchain of a source blockchain network to a target blockchain of a target blockchain network. The software in memory 110 may further include a suitable operating system (OS) 111. The OS 111 essentially controls the execution of other computer programs, such as possibly software 112.

If the computer system 100 is a PC, workstation, intelligent device or the like, the software in the memory 110 may further include a basic input output system (BIOS) 122. The BIOS is a set of essential software routines that initialize and test hardware at startup, start the OS 111, and support the transfer of data among the hardware devices. The BIOS is stored in ROM so that the BIOS can be executed when the computer system 100 is activated.

When the computer system 100 is in operation, the processor 105 is configured for executing software 112 stored within the memory 110, to communicate data to and from the memory 110, and to generally control operations of the computer system 100 pursuant to the software. The methods described herein and the OS 111, in whole or in part, but typically the latter, are read by the processor 105, possibly buffered within the processor 105, and then executed.

Software 112 may further be provided stored on any computer readable medium, such as storage 120, for use by or in connection with any computer related system or method. The storage 120 may comprise a disk storage such as HDD storage.

In exemplary embodiments, a conventional keyboard 150 and mouse 155 can be coupled to the input/output controller 135. Other output devices such as the I/O devices 145 may include input devices, for example but not limited to a printer, a scanner, microphone, and the like. Finally, the I/O devices 10, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The I/O devices 10, 145 may be any generalized cryptographic card or smart card known in the art. The computer system 100 can further include a display controller 125 coupled to a display 130. In exemplary embodiments, the computer system 100 can further include a network interface for coupling to a network 160, like an intranet or the Internet. The network can be an IP-based network for communication between the computer system 100 and any external server, like server 170, other client and the like via a broadband connection. The network 160 transmits and receives data between the computer system 100 and server 170. In exemplary embodiments, network 160 may be a managed IP network administered by a service provider. The network 160 may be implemented in a wireless fashion, e.g., using wireless protocols and technologies, such as Wi-Fi, WiMAX, etc. The network 160 may also be a packet-switched network such as a local area network, wide area network, metropolitan area network, Internet network, or other similar type of network environment. The network may be a fixed wireless network, a wireless local area network (LAN), a wireless wide area network (WAN) a personal area network (PAN), a virtual private network (VPN), intranet or other suitable network system and includes equipment for receiving and transmitting signals. The server 170 may be a member, may be used by a member or may be provided with information identifying a member of the source blockchain network. The target as well as the source blockchain network may be comprised of further or additional servers accessible via the network 160.

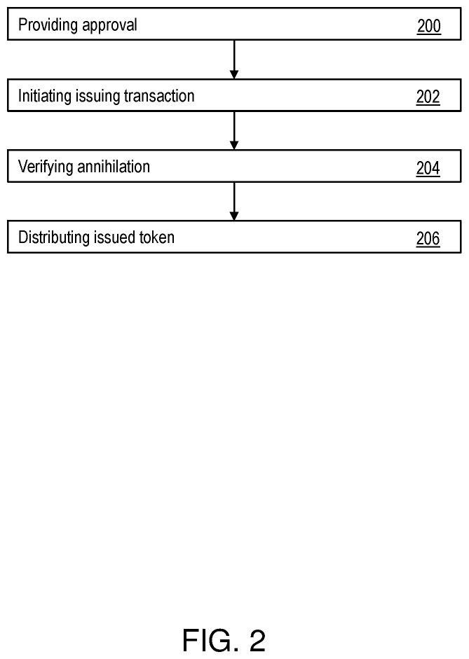

FIG. 2 shows a schematic flow diagram of an exemplary method for transferring at least one source token of a source set of tokens from a source blockchain of a source blockchain network to a target blockchain of a target blockchain network. In step 200, a receiver (Bob), who is a member of the target blockchain network, provides for a set of transfer conditions a receiver approval of the transfer of the at least one source token to the target blockchain network. The receiver approval may, e.g., be provided in reply to a request by a sender (Alice), who is a member of the source blockchain network. The receiver may be authorized to initiate an issuing of at least one target token extending the target set of tokens within the target blockchain network. The set of transfer conditions with the receiver approval may be configured to be used for verifying a successful annihilation of the at least one source token in the source blockchain

In step 202, an issuing transaction of the at least one target token is issued in the target blockchain of the target blockchain network by the receiver. The issuing transaction may be assigned with metadata comprising the set of transfer conditions with the receiver approval of step 200. Validity of the at least one target token within the target blockchain network may require a successful verification of the annihilating of the at least one source token in the source blockchain.

In step 204, the annihilation of the at least one source token in the source blockchain of the source blockchain network is verified using the set of transfer conditions with the receiver approval. A successful verification may prove that the target token is valid, i.e. backed by an annihilated source token. In step 206, the backed target token may be distributed by the receiver. For example, the target token may be sent to a destination address of the target blockchain assigned to the sender or a destination address of the target blockchain indicated by the sender.

The sender may send a sender approval of the transfer to the receiver of the target blockchain. The sender may verify the issuing of the target token and may initiate the annihilation of the source token.

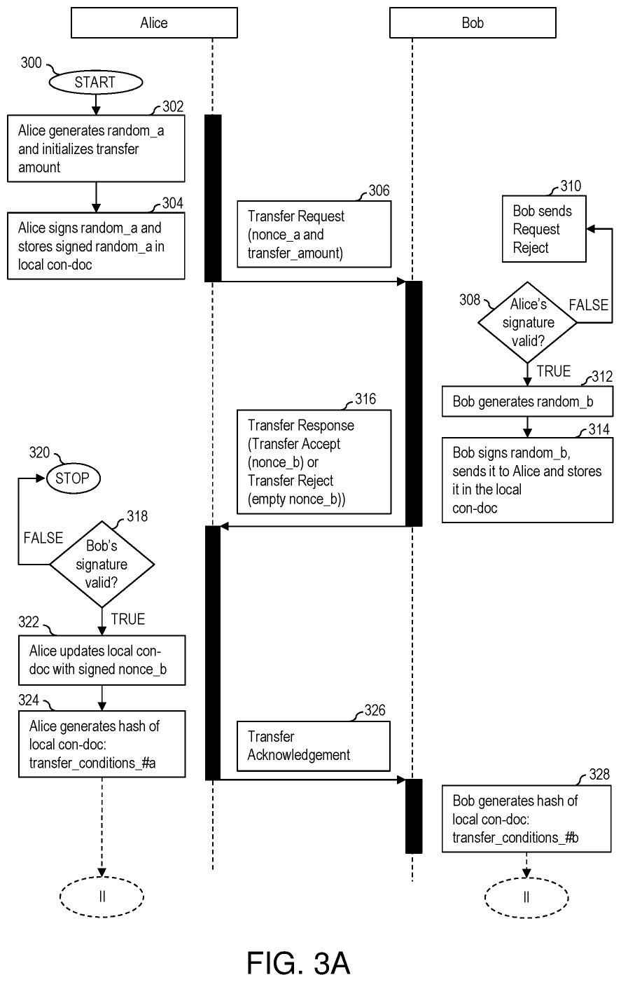

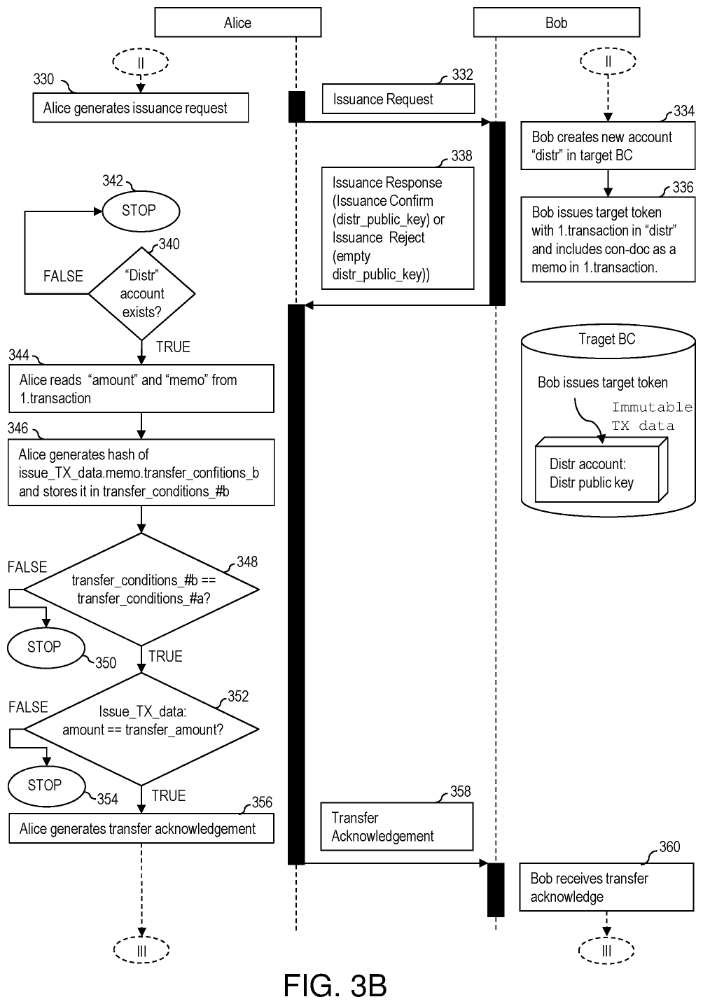

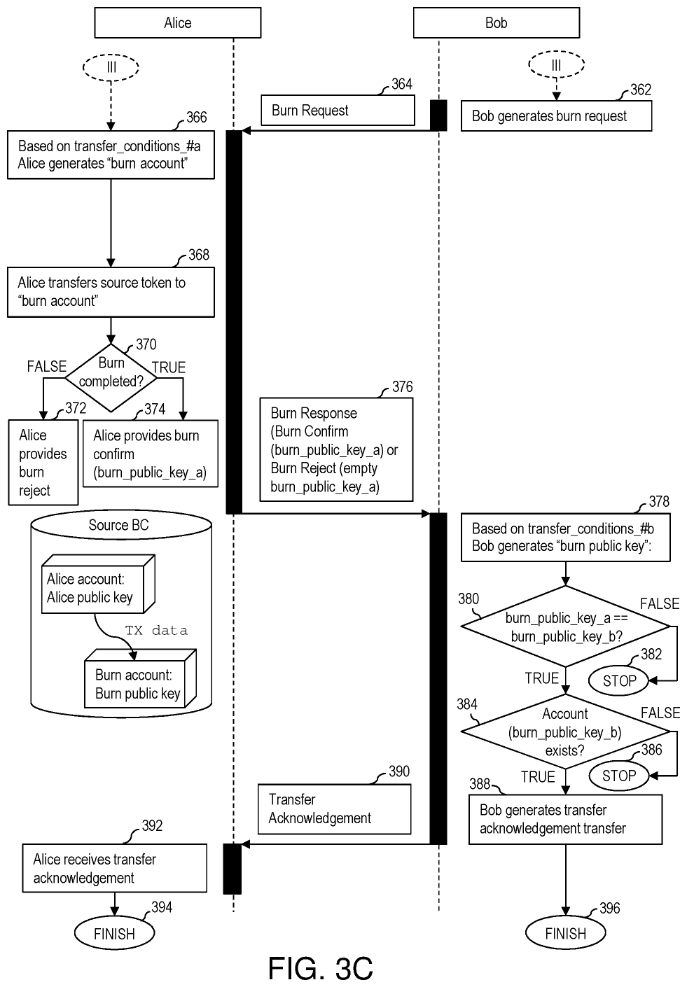

FIG. 3 show a schematic flow diagram of an exemplary method for transferring at least one source token of a source set of tokens from a source blockchain of a source blockchain network to a target blockchain of a target blockchain network. FIG. 3A illustrates a first phase of the transferring. The first phase may comprise a receiver approval, e.g., in form of a signed nonce (nonce_b), being provided by the receiver (Bob). An overall goal of the first phase may, e.g., be to agree on a common form of data record with the transfer conditions (con-doc), which may comprise a random sequence of bytes (nonce_a) signed by Alice to indicate her approval and a random sequence of bytes (nonce_b) signed by Bob to indicate his approval. Both parties, Alice and Bob, may hold local copies of the transfer conditions (con-doc) referred to as transfer_conditions_a and transfer_conditions_b, respectively. After successful execution of the first phase, the local copies of both parties may comprise the same values. Bob assign transfer_conditions_b as metadata to an issuing transaction, e.g., include it in a record of the respective transaction in the target blockchain during a subsequent phase. Alice may use transfer_conditions_a for generating an annihilation destination address in the source blockchain to which the source token is to be transferred for annihilation in a subsequent phase. The con-doc may comprise further auxiliary data, like attributes of the tokens to be transferred. For example, con-doc may comprise a number of tokens to be transferred (transfer_amount).

In step 300, the method is started. In step 302, Alice may generate a random string random_a for use as an approval of the transfer and initialize a transfer amount providing an attribute characterizing of the source token to be transferred. In step 304, may Alice signs random_a using a private cryptographic key assigned to Alice. The signed random_a may represent Alice's approval of the transfer. Alice may store the signed random_a in a local copy of transfer conditions con-doc, e.g., in form of a JSON document:

```
“Alice's local con-doc
transfer_conditions_a = {
  nonce_a: “signed random_a”,
  nonce_b: NIL,
  transfer_amount: Number
}”
```

In step 306, a transfer request comprising the signed nonce_a and the transfer_amount may be sent to Bob. In step 308, Bob may check if Alice's signature is valid. If the signature is invalid, Bob may send a request reject to Alice in step 310. If the signature is valid, Bob may generate a random string random_b for use as an approval of the requested transfer. The signed random_b may represent Bob's approval to the requested transfer. In step 314, Bob may sign random_b using a private cryptographic key assigned to Bob. Bob may send signed random_b to Alice and store the signed random_b in a local copy of con-doc:

```
“Bob's local con-doc
transfer_conditions_b = {
  nonce_a: “signed random_a”,
  nonce_b: “signed random_b”,
  transfer_amount: Number
}”
```

In step 316, a transfer response may be sent to Alice, either comprising a transfer accept (signed nonce_b) or a transfer reject (empty nonce_b). In step 318, Alice may check if Bob's signature is valid. If the signature is invalid, the method may stop in step 320. If the signature is valid, Alice may update the local copy of con-doc with the signed nonce_b in step 322:

```
“Alice's local con-doc
transfer_conditions_a = {
  nonce_a: “signed random_a”,
  nonce_b: “signed random_b”,
  transfer_amount: Number
}”
```

In step 324, Alice may generate a hash of the local copy of con-doc resulting in transfer_conditions_#a, e.g. using a cryptographic SHA-2 hash function like SHA-256. In step 326, Alice may send a transfer acknowledgement to Bob. In step 328, Bob may generate a hash of the local copy of con-doc resulting in transfer_conditions_#b, e.g. using a cryptographic SHA-2 hash function like SHA-256.

FIG. 3B illustrates a second phase of the transferring. The second phase may comprise an initiating of an issuing of a target token in the target blockchain by Bob. An overall goal of the second phase may be a creation of an immutable, i.e., unchangeable, issuing transaction of a at least one target token in the target blockchain. The issuing transaction may be executed by Bob. Bob may be required to include his local instance of the con-doc agreed on in the first phase, i.e., transfer_conditions_b, as metadata. For example, transfer_conditions_b may be added as a memo field of the transaction. Once added, Bob may no longer be able to delete or alter transaction data stored in target blockchain. Alice by having the access to the, e.g., public, target blockchain is enabled to verify the issuing transaction.

In step 330, Alice may generate an issuance request. In step 332, the issuance request may be sent to Bob. In step 334, Bob may create a new account “distr” in the target blockchain identified by the public cryptographic key distr_pub_key. In step 336, Bob may issue new tokens in the target blockchain by creating a first transaction in “distr”. Bob may include con-doc as a memo in the issuing transaction:

```
“Immutable TX data: Bob account, Distr account, token name, amount,
memo = {
  transfer_conditions_b: {
    nonce_a: “signed random_a”,
    nonce_b: “signed random_b”,
    transfer_amount: Number
  }
}”
```

In step 338, Bob may send an issuance response to Alice, comprising either an issuance confirm (distr_public_key) or an issuance reject (empty distr_public_key). In step 340, Alice may check if the “distr” account exists. In case the “distr” account does not exist the method may stop in step 342. In case the “distr” account exists, Alice may read an “amount” and “memo” from the first transaction of “distr” in step 344. Alice may add the data read to the local copy of the issuing transaction data, i.e. issue-tx-doc:

```
“Alice's local issue-tx-doc
issue_TX_data = {
  amount: “issued tokens”,
  memo: {
    transfer_conditions_b: {
      nonce_a: “signed random_a”,
      nonce_b: “signed random_b”,
      transfer_amount: Number
    }
  }
}”
```

In step 346, Alice may generate a hash of issue_TX_data.memo.transfer_confitions_b, e.g., using SHA-256, and stores it as transfer_conditions_#b. In step 348, Alice may check if transfer_conditions_#b==transfer_conditions_#a. If that false, the method may stop in step 350. If it is true, Alice may check in step 352, is amount==transfer_amount. If this is false, the method may stop in step 354. If it is true, Alice may generate a transfer acknowledgement in step 356: “verification successful”. In step 358, the transfer acknowledgement may be sent to Bob. In step 360, Bob may receive the transfer acknowledge: “verification successful”.

FIG. 3C illustrates a third phase of the transferring. The third phase may comprise a verification of the annihilation by Bob. An overall goal of the third phase may be a completion of the token transfer by annihilating in the source blockchain, i.e., making them unusable. Alice after a successful verification of the token issued by Bob tokens during the second phase may safely generate an annihilation destination address in the source blockchain and transfer tokens to the annihilation destination address in order to annihilate them. i.e., make them unusable/non-spendable. The annihilation destination address may be generated using Alice local transfer_conditions_b. From the transfer to the annihilation destination address the annihilation is verifiable, i.e., that the token issued in the target blockchain network is valid, i.e., backed by annihilated tokens in the source blockchain network, completing the cross-blockchain transaction.

In step 362, Bob generates an annihilation, i.e., burn request. In step 364, the burn request is sent to Alice. In step 366, based on transfer_conditions_#a Alice may generate an annihilation destination address “burn account” identified with a sequence of alphanumerical values resembling the form of a public cryptographic key “burn public key” burn_public_key_a=fn(transfer_conditions_#a), where:

```
fn(transfer_conditions_hash) {
  transfer_conditions_hash = “prefix” + transfer_conditions_hash;
  return transfer_conditions_hash + CRC(transfer_conditions_hash);
}.
```

In step 368, Alice may transfer at least one source token from an account identified with Alice's public key to the “burn account” identified with by the “burn public key”. In step 370, Alice may check if the burn is completed. If it is incomplete, Alice may provide a burn reject in step 372. If it is complete, Alice may provide a burn confirm (burn_public_key_a) in step 374. In step 376, Alice may send a burn response to Bob, comprising either the burn confirm (burn_public_key_a) or the burn reject (empty burn_public_key_a).

In step 378, based on transfer_conditions_#b Bob may generate the “burn public key” burn_public_key_b=fn(transfer_conditions_#b), where

```
fn(transfer_conditions_hash) {
  transfer_conditions_hash = “prefix” + transfer_conditions_hash;
  return transfer_conditions_hash + CRC(transfer_conditions_hash);
}
```

In step 380, Bob may check if burn_public_key_a==burn_public_key_b. If this is false, the method may stop in step 382. If it is true, Bob may check in step 384 if the account identified by burn_public_key_b exists. If it does not exist, the method may stop in step 386. If it exists, Bob may generate a transfer acknowledgement in step 388: “transfer successful”. In step 390, the transfer acknowledgment may be sent to Alice. In step 392, Alice may receive the transfer acknowledgement: “transfer successful”. In steps 394 and 396, the method finishes for Alice and Bob.

It is understood that one or more of the aforementioned embodiments of the invention may be combined as long as the combined embodiments are not mutually exclusive. Ordinal numbers, like e.g. ‘first’ and ‘second’, are used herein to indicate different element assigned with the same name, but do not necessarily establish any order of the respective elements, unless otherwise indicated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Possible combinations of features described above may be the following:

1. A method for transferring at least one source token of a source set of tokens from a source blockchain of a source blockchain network to a target blockchain of a target blockchain network, the source blockchain network being configured for issuing and transferring the tokens of the source set of tokens within the source blockchain network using the source blockchain, the target blockchain network being configured for issuing and transferring tokens of a target set of tokens within the target blockchain network using the target blockchain, the method comprising:

providing for a set of transfer conditions a receiver approval of the transfer of the at least one source token to the target blockchain network from a receiver, the receiver being a member of the target blockchain network authorized to initiate an issuing of at least one target token extending the target set of tokens within the target blockchain network, the set of transfer conditions with the receiver approval being configured to be usable for verifying a successful annihilation of the at least one source token in the source blockchain,

initiating an issuing transaction of the at least one target token in the target blockchain of the target blockchain network by the receiver, the issuing transaction being assigned with metadata, the metadata comprising the set of transfer conditions with the receiver approval, validity of the at least one target token within the target blockchain network requiring a successful verification of the annihilating of the at least one source token in the source blockchain,

verifying the annihilation of the at least one source token in the source blockchain of the source blockchain network using the set of transfer conditions with the receiver approval.

2. The method of item 1, the receiver approval comprising a receiver nonce signed with a receiver private cryptographic key assigned to the receiver, the signature with the receiver private cryptographic key being verifiable using a receiver public cryptographic key counterpart of the receiver private cryptographic key.
3. The method of any of the preceding items, the method further comprising receiving for the set of transfer conditions a sender approval of the transfer of the at least one source token to the target blockchain network from a sender, the sender being a member of the source blockchain network authorized to initiate a transfer of the at least one source token within the source blockchain network.
4. The method of item 3, the received sender approval comprising a sender nonce signed with a sender private cryptographic key assigned to the sender, the method further comprising verifying the received sender approval using a sender public cryptographic key counterpart of the sender private cryptographic key.
5. The method of any of items 3 to 4, the sender approval being received from the sender as part of a transfer request for transferring the at least one source token from the source blockchain network to the target blockchain network.
6. The method of item 5, the transfer request comprising at least one attribute of the at least one source token to be transferred.
7. The method of any of items 3 to 6, the method further comprising sending the receiver approval to the sender for verification.
8. The method of item 7, receiving a first verification confirmation of the verification of the receiver approval from the sender.
9. The method of any of items 1 to 2, the receiver being a member of the source blockchain network as well, authorized to initiate a transfer of the at least one source token within the source blockchain network.
10. The method of any of the preceding items, the set of transfer conditions assigned to the issuing transaction of the at least one target token as metadata being publicly accessible.
11. The method of any of the preceding items, the method further comprising sending an identifier of a destination address of the issuing transaction of the at least one target token to the sender for verification.
12. The method of item 12, the method further comprising receiving a second verification confirmation of the verification of the issuing transaction from the sender.
13. The method of any of the preceding items, destination addresses for transfers of the tokens of the source set of tokens within the source blockchain network being calculated using a public cryptographic key, for transfers of the tokens of the source set of tokens from the destination addresses a private cryptographic key counterpart of the public cryptographic key used for calculating the respective destination address being required,

the verification of the annihilation comprising determining if the at least one source token has been transferred to an annihilation destination address within the source blockchain network, the calculation of the annihilation destination address comprising:
applying a first one-way function on at least a portion of the set of transfer conditions, the portion of the set of transfer conditions at least comprising the receiver approval and the sender approval,
using the result of the first one-way function as a public cryptographic key with no private cryptographic key counterpart for the calculating of the annihilation destination address, the at least one source token being non-transferable from the annihilation destination address due to the non-existing of a private cryptographic key counterpart of the public cryptographic key resulting from the first one-way function.
   14. The method of item 13, the first one-way function being a first hash function
   15. The method of any of items 13 to 14, the calculation of the destination address comprising applying a second one-way function to the result of the first one-way function.
   16. The method of item 15, the second one-way function being a second hash function.
   17. The method of any of items 13 to 16, the portion of the set of transfer conditions comprising the full set of transfer conditions.
   18. The method of any of the preceding items, the verifying of the annihilation further comprising checking that the annihilated at least one source token satisfies the transfer conditions according to the set of transfer conditions.
   19. The method of item 18, a transfer condition of the set of transfer conditions defining an attribute of the at least one source token.
   20. The method of item 19, the at least one target token being required to comprise the same attribute as defined by the transfer condition of the set of transfer conditions for the at least one source token.
   21. The method of any of the preceding items, if the verifying of the annihilation being successful, sending a third verification confirmation of the annihilation of the at least one source token to the sender.
   22. The method of any of the preceding items, the set of transfer conditions being provided in form of a JSON file.
   23. The method of any of the preceding items, a plurality of source token being transferred from the source blockchain of the source blockchain network to the target blockchain of the target blockchain network, the set of transfer conditions comprising transfer conditions for the plurality of source token, the receiver approval approving the transfer of the plurality of source token, the issuing transaction defining an issuing of one or more target token such that the one or more target token issued satisfy the transfer conditions of the set of transfer conditions, the verifying of the annihilation being performed for each source token of the plurality of source token.
   24. A computer program product for transferring at least one source token of a source set of tokens from a source blockchain of a source blockchain network to a target blockchain of a target blockchain network, the source blockchain network being configured for issuing and transferring the tokens of the source set of tokens within the source blockchain network using the source blockchain, the target blockchain network being configured for issuing and transferring tokens of a target set of tokens within the target blockchain network using the target blockchain, the computer program product comprising a computer readable storage medium having program instructions embodied therewith, the program instructions executable by a computer system to cause the computer system to:

providing for a set of transfer conditions a receiver approval of the transfer of the at least one source token to the target blockchain network from a receiver, the receiver being a member of the target blockchain network authorized to initiate an issuing of at least one target token extending the target set of tokens within the target blockchain network, the set of transfer conditions with the receiver approval being configured to be usable for verifying a successful annihilation of the at least one source token in the source blockchain,

initiating an issuing transaction of the at least one target token in the target blockchain of the target blockchain network by the receiver, the issuing transaction being assigned with metadata, the metadata comprising the set of transfer conditions with the receiver approval, validity of the at least one target token within the target blockchain network requiring a successful verification of the annihilating of the at least one source token in the source blockchain,

verifying the annihilation of the at least one source token in the source blockchain of the source blockchain network using the set of transfer conditions with the receiver approval.

25. A computer system for transferring at least one source token of a source set of tokens from a source blockchain of a source blockchain network to a target blockchain of a target blockchain network, the source blockchain network being configured for issuing and transferring the tokens of the source set of tokens within the source blockchain network using the source blockchain, the target blockchain network being configured for issuing and transferring tokens of a target set of tokens within the target blockchain network using the target blockchain, the computer system comprising a processor and a memory storing computer-executable program instructions, execution of the program instructions by the processor causing the processor to control the computer system to:

providing for a set of transfer conditions a receiver approval of the transfer of the at least one source token to the target blockchain network from a receiver, the receiver being a member of the target blockchain network authorized to initiate an issuing of at least one target token extending the target set of tokens within the target blockchain network, the set of transfer conditions with the receiver approval being configured to be usable for verifying a successful annihilation of the at least one source token in the source blockchain,

initiating an issuing transaction of the at least one target token in the target blockchain of the target blockchain network by the receiver, the issuing transaction being assigned with metadata, the metadata comprising the set of transfer conditions with the receiver approval, validity of the at least one target token within the target blockchain network requiring a successful verification of the annihilating of the at least one source token in the source blockchain,

verifying the annihilation of the at least one source token in the source blockchain of the source blockchain network using the set of transfer conditions with the receiver approval.

1. A method for transferring at least one source token of a source set of tokens from a source blockchain of a source blockchain network to a target blockchain of a target blockchain network, the source blockchain network being configured for issuing and transferring the tokens of the source set of tokens within the source blockchain network using the source blockchain, the target blockchain network being configured for issuing and transferring tokens of a target set of tokens within the target blockchain network using the target blockchain, the method comprising:
providing, for a set of transfer conditions, a receiver approval of the transfer of the at least one source token to the target blockchain network from a receiver, the receiver being a member of the target blockchain network authorized to initiate an issuing of at least one target token extending the target set of tokens within the target blockchain network, the set of transfer conditions with the receiver approval being configured to be usable for verifying a successful annihilation of the at least one source token in the source blockchain;
initiating an issuing transaction of the at least one target token in the target blockchain of the target blockchain network by the receiver, the issuing transaction being assigned with metadata, the metadata comprising the set of transfer conditions with the receiver approval, validity of the at least one target token within the target blockchain network requiring a successful verification of the annihilating of the at least one source token in the source blockchain;
verifying the annihilation of the at least one source token in the source blockchain of the source blockchain network using the set of transfer conditions with the receiver approval.

2. The method of claim 1, the receiver approval comprising a receiver nonce signed with a receiver private cryptographic key assigned to the receiver, the signature with the receiver private cryptographic key being verifiable using a receiver public cryptographic key counterpart of the receiver private cryptographic key.

3. The method of claim 1, the method further comprising receiving, for the set of transfer conditions, a sender approval of the transfer of the at least one source token to the target blockchain network from a sender, the sender being a member of the source blockchain network authorized to initiate a transfer of the at least one source token within the source blockchain network.

4. The method of claim 3, the received sender approval comprising a sender nonce signed with a sender private cryptographic key assigned to the sender, the method further comprising:
verifying the received sender approval using a sender public cryptographic key counterpart of the sender private cryptographic key.

5. The method of claim 3, the sender approval being received from the sender as part of a transfer request for transferring the at least one source token from the source blockchain network to the target blockchain network.

6. The method of claim 5, the transfer request comprising at least one attribute of the at least one source token to be transferred.

7. The method of claim 3, the method further comprising sending the receiver approval to the sender for verification.

8. The method of claim 7, receiving a first verification confirmation of the verification of the receiver approval from the sender.

9. The method of claim 1, the receiver being a member of the source blockchain network as well, authorized to initiate a transfer of the at least one source token within the source blockchain network.

10. The method of claim 1, the set of transfer conditions assigned to the issuing transaction of the at least one target token as metadata being publicly accessible.

11. The method of claim 1, the method further comprising sending an identifier of a destination address of the issuing transaction of the at least one target token to the sender for verification.

12. The method of claim 11, the method further comprising receiving a second verification confirmation of the verification of the issuing transaction from the sender.

13. The method of claim 1, destination addresses for transfers of the tokens of the source set of tokens within the source blockchain network being calculated using a public cryptographic key, for transfers of the tokens of the source set of tokens from the destination addresses a private cryptographic key counterpart of the public cryptographic key used for calculating the respective destination address being required;
the verification of the annihilation comprising determining if the at least one source token has been transferred to an annihilation destination address within the source blockchain network, the calculation of the annihilation destination address comprising:
applying a first one-way function on at least a portion of the set of transfer conditions, the portion of the set of transfer conditions at least comprising the receiver approval and the sender approval, and
using the result of the first one-way function as a public cryptographic key with no private cryptographic key counterpart for the calculating of the annihilation destination address, the at least one source token being non-transferable from the annihilation destination address due to the non-existing of a private cryptographic key counterpart of the public cryptographic key resulting from the first one-way function.

14. The method of claim 13, the first one-way function being a first hash function

15. The method of claim 13, the calculation of the destination address comprising applying a second one-way function to the result of the first one-way function.

16. The method of claim 15, the second one-way function being a second hash function.

17. The method of claim 13, the portion of the set of transfer conditions comprising the full set of transfer conditions.

18. The method of claim 1, the verifying of the annihilation further comprising checking that the annihilated at least one source token satisfies the transfer conditions according to the set of transfer conditions.

19. The method of claim 18, a transfer condition of the set of transfer conditions defining an attribute of the at least one source token.

20. The method of claim 19, the at least one target token being required to comprise the same attribute as defined by the transfer condition of the set of transfer conditions for the at least one source token.

21. The method of claim 1, if the verifying of the annihilation being successful, sending a third verification confirmation of the annihilation of the at least one source token to the sender.

22. The method of claim 1, the set of transfer conditions being provided in form of a JSON file.

23. The method of claim 1, a plurality of source token being transferred from the source blockchain of the source blockchain network to the target blockchain of the target blockchain network, the set of transfer conditions comprising transfer conditions for the plurality of source token, the receiver approval approving the transfer of the plurality of source token, the issuing transaction defining an issuing of one or more target token such that the one or more target token issued satisfy the transfer conditions of the set of transfer conditions, the verifying of the annihilation being performed for each source token of the plurality of source token.

24. A computer program product for transferring at least one source token of a source set of tokens from a source blockchain of a source blockchain network to a target blockchain of a target blockchain network, the source blockchain network being configured for issuing and transferring the tokens of the source set of tokens within the source blockchain network using the source blockchain, the target blockchain network being configured for issuing and transferring tokens of a target set of tokens within the target blockchain network using the target blockchain, the computer program product comprising a computer readable storage medium having program instructions embodied therewith, the program instructions executable by a computer system to cause the computer system to:
providing, for a set of transfer conditions, a receiver approval of the transfer of the at least one source token to the target blockchain network from a receiver, the receiver being a member of the target blockchain network authorized to initiate an issuing of at least one target token extending the target set of tokens within the target blockchain network, the set of transfer conditions with the receiver approval being configured to be usable for verifying a successful annihilation of the at least one source token in the source blockchain;
initiating an issuing transaction of the at least one target token in the target blockchain of the target blockchain network by the receiver, the issuing transaction being assigned with metadata, the metadata comprising the set of transfer conditions with the receiver approval, validity of the at least one target token within the target blockchain network requiring a successful verification of the annihilating of the at least one source token in the source blockchain;
verifying the annihilation of the at least one source token in the source blockchain of the source blockchain network using the set of transfer conditions with the receiver approval.

25. A computer system for transferring at least one source token of a source set of tokens from a source blockchain of a source blockchain network to a target blockchain of a target blockchain network, the source blockchain network being configured for issuing and transferring the tokens of the source set of tokens within the source blockchain network using the source blockchain, the target blockchain network being configured for issuing and transferring tokens of a target set of tokens within the target blockchain network using the target blockchain, the computer system comprising a processor and a memory storing computer-executable program instructions, execution of the program instructions by the processor causing the processor to control the computer system to:
providing, for a set of transfer conditions, a receiver approval of the transfer of the at least one source token to the target blockchain network from a receiver, the receiver being a member of the target blockchain network authorized to initiate an issuing of at least one target token extending the target set of tokens within the target blockchain network, the set of transfer conditions with the receiver approval being configured to be usable for verifying a successful annihilation of the at least one source token in the source blockchain;
initiating an issuing transaction of the at least one target token in the target blockchain of the target blockchain network by the receiver, the issuing transaction being assigned with metadata, the metadata comprising the set of transfer conditions with the receiver approval, validity of the at least one target token within the target blockchain network requiring a successful verification of the annihilating of the at least one source token in the source blockchain;
verifying the annihilation of the at least one source token in the source blockchain of the source blockchain network using the set of transfer conditions with the receiver approval.
